(19) United States
(12) Patent Application Publication
(10) Pub. No.: US 2024/0266689 A1
(43) Pub. Date: Aug. 8, 2024

(54) METHOD FOR MANUFACTURING POWER STORAGE DEVICE

(71) Applicant: Prime Planet Energy & Solutions, Inc., Tokyo (JP)

(72) Inventor: Hideaki YAMANAKA, Kusatsu-shi (JP)

(21) Appl. No.: 18/430,648

(22) Filed: Feb. 2, 2024

(30) Foreign Application Priority Data
Feb. 8, 2023 (JP) 2023-017771

(51) Int. Cl. H01M 50/536; B23K 26/21; H01M 50/528; H01M 50/54

(52) U.S. Cl. CPC H01M 50/536; B23K 26/21; H01M 50/528; H01M 50/54

(57) ABSTRACT

The present disclosure provides a method for manufacturing a power storage device with increased welding stability in welding current collecting foils and a current collector, the power storage device including a positive electrode including stacked positive electrode current collecting foils and a positive electrode current collector connected to the positive electrode current collecting foils and a negative electrode including stacked negative electrode current collecting foils and a negative electrode current collector connected to the negative electrode current collecting foils. The method includes applying, while pressing the current collecting foils against the current collector, a tensile force to the stacked current collecting foils pressed in a predetermined straight line direction in at least one of the positive electrode and the negative electrode, and irradiating a portion of a surface of the stacked current collecting foils pressed against the current collector located in the predetermined straight line direction with laser light.

### CROSS REFERENCE OF RELATED APPLICATION

This application claims the benefit of priority to Japanese Patent Application No. 2023-017771 filed on Feb. 8, 2023. The entire contents of this application are hereby incorporated herein by reference.

### BACKGROUND OF THE DISCLOSURE

### 1. Field

The present disclosure relates to a method for manufacturing a power storage device.

### 2. Background

Conventionally, as a technology for joining current collecting foils of each electrode and a current collector included in an electrode body, resistance welding or ultrasonic welding has been widely used. On the other hand, from a viewpoint of reducing costs, development of technology for joining current collecting foils and a current collector by laser welding is underway. For example, Japanese Laid-open Patent Publication No. 2016-030280, Japanese Laid-open Patent Publication No. 2014-136242, and Japanese Laid-open Patent Publication No. 2019-067570 disclose welding jigs that have a through hole through which laser light passes. The welding jigs are configured to pressurize stacked current collecting foils around the through hole in a stacking direction. For example, in Japanese Laid-open Patent Publication No. 2016-030280, a protrusion is provided in a metal plate (for example, a current collector) under a position where laser welding of metal foils (for example, current collecting foils) is performed. By pressing a portion therearound by a jig, the metal foils and the metal plate can be brought into close contact with each other and thus be laser welded.

### SUMMARY

Incidentally, when the stacked current collecting foils and the current collector are laser-welded, it is preferable that there is no gap between the current collecting foils and between the current collecting foils and the current collector. When there are gaps therebetween, inconveniences, such as generation of blowholes, generation of spatters, rapture of metal foils, or the like, can occur, so that welding stability is reduced. A position where laser welding of the current collecting foils is performed is irradiated with laser light, and therefore, it is difficult to directly press a portion that is irradiated with laser light such that no gap is generated therein.

In view of the foregoing, the present technology has been devised and it is therefore a main object of the present disclosure to provide a method for manufacturing a power storage device with increased welding stability in welding current colleting foils and a current collector.

The present disclosure provides a method for manufacturing a power storage device, the power storage device including a positive electrode including stacked positive electrode current collecting foils and a positive electrode current collector connected to the stacked positive electrode current collecting foils, and a negative electrode including stacked negative electrode current collecting foils and a negative electrode current collector connected to the stacked negative electrode current collecting foils. The manufacturing method disclosed herein includes applying, while pressing the stacked current collecting foils against the current collector, a tensile force to the stacked current collecting foils that are pressed in a predetermined straight line direction in at least one of the positive electrode and the negative electrode, and irradiating a portion of a surface of the stacked current collecting foils that are pressed against the current collector located in the predetermined straight line direction with laser light.

According to the manufacturing method, wrinkles of the current collecting foils can be uniformly stretched by applying a tensile force to the stacked current collecting foils in the predetermined straight line direction. Thus, gaps between the current collecting foils can be reduced due to reduction of the wrinkles of the current collecting foils that are pressed against the current collector. As a result, in laser welding the stacked positive electrode current collecting foils that are pressed against the current collector and the current collector, welding stability can be increased.

### BRIEF DESCRIPTION OF THE DRAWINGS

FIG. 1 is a schematic cross-sectional view roughly illustrating a configuration of a nonaqueous electrolyte secondary battery according to one preferred embodiment.

FIG. 2 is an exploded view schematically illustrating a configuration of an electrode body of the nonaqueous electrolyte secondary battery according to one preferred embodiment.

FIG. 3 is a schematic view roughly illustrating a laser welding method according to a first preferred embodiment.

FIG. 4 is a schematic view roughly illustrating a laser welding method according to a second preferred embodiment.

FIG. 5 is a schematic view illustrating a method for pressurizing a laser light irradiation portion in a stacking direction of current collecting foils.

FIG. 6 is a schematic view roughly illustrating a laser welding method according to a third preferred embodiment.

### DETAILED DESCRIPTION OF THE PREFERRED EMBODIMENTS

A technology disclosed herein will be described below. Matters other than matters specifically mentioned in this specification (for example, a method for laser-welding current collecting foils of an electrode and a current collector) and necessary for carrying out the technology disclosed herein (for example, a method for assembling a power storage device, or the like) can be understood as design matters for those skilled in the art based on the related art in the related field. The contents of the technology disclosed herein can be carried out based on contents disclosed in this specification and the common general technical knowledge in the field.

Each of the accompanying drawings is schematic and a dimensional relation (of length, width, thickness, or the like) does not necessarily reflect an actual dimensional relation. In the drawings described below, the members and parts with the same operation are denoted by the same reference signs and the overlapping description may be omitted or simplified. In this specification, when a numerical range is described as “A to B (herein, A and B are arbitrary numerical values),” the notation means “A or more and B or less” and also encompasses “a range that exceeds A and is less than B,” “a range that exceeds A and is B or less,” and “a range that is A or more and less than B.”

As used in this specification, the term “power storage device” refers to a device that can perform charging and discharging. The power storage device encompasses a battery, such as a primary battery, a secondary battery (for example, a lithium-ion secondary battery, a nickel-hydrogen battery), or the like, and a capacitor (physical battery), such as an electric double layer capacitor or the like. A nonaqueous electrolyte secondary battery that is one preferred embodiment of a power storage device that is manufactured by a manufacturing method disclosed herein will be described below. Note that a power storage device that is manufactured according to the present technology is not limited to a nonaqueous electrolyte secondary battery.

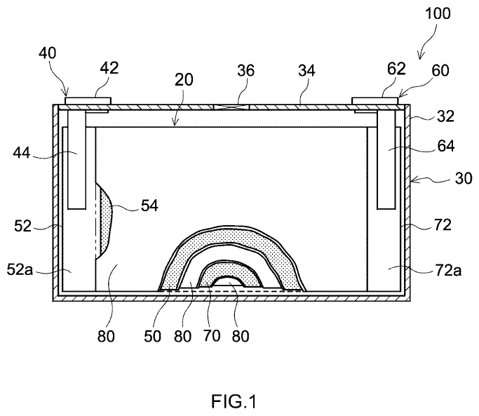

FIG. 1 is a schematic cross-sectional view roughly illustrating a configuration of a nonaqueous electrolyte secondary battery 100 according to one preferred embodiment. The nonaqueous electrolyte secondary battery 100 includes an electrode body 20, a case 30, a positive electrode 40, a negative electrode plate 70, and a nonaqueous electrolyte (not illustrated). The positive electrode 40 includes a positive electrode terminal 42, a positive electrode current collector 44, and a positive electrode plate 50. A negative electrode 60 incudes a negative electrode terminal 62, a negative electrode current collector 64, and a negative electrode plate 70. Although not particularly limited, in this preferred embodiment, the nonaqueous electrolyte secondary battery 100 is a lithium-ion secondary battery.

As illustrated in FIG. 1, the nonaqueous electrolyte secondary battery 100 is a rectangular sealed-type battery constructed such that the electrode body (wound electrode body) 20 with a flat shape and a nonaqueous electrolyte (not illustrated) are accommodated in the case 30. The case 30 includes a case body 32 with an opening and a sealing member 34 that seals the opening. The sealing member 34 has a plate shape herein. The sealing member 34 includes a positive electrode terminal 42 and a negative electrode terminal 62 that are used for external connection. The sealing member 34 is provided with a thin safety valve 36 that is set to, when an inner pressure of the case 30 is increased to a predetermined level or more, release the inner pressure. Furthermore, in the case 30, an injection port (not illustrated) used for injecting the nonaqueous electrolyte is provided. A material of the case 30 is preferably a metallic material with a high strength, a light weight, and a good thermal conductivity. Examples of the metallic material include aluminum, steel, or the like.

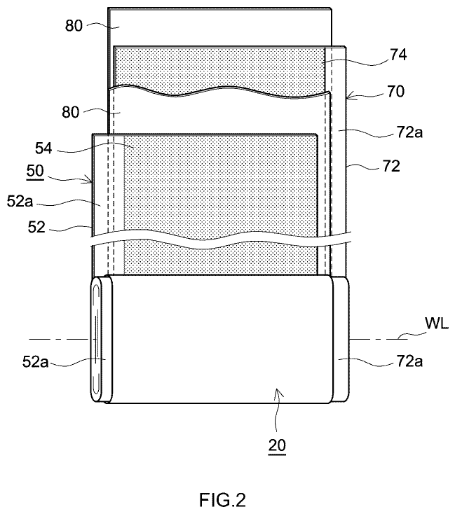

FIG. 2 is an exploded view schematically illustrating a configuration of the electrode body 20 of the nonaqueous electrolyte secondary battery 100 according to one preferred embodiment. In FIG. 2, the electrode body 20 is a wound electrode body in which the long-sheet shaped positive electrode plate 50 and the long-sheet shaped negative electrode plate 70 are stacked with two long-sheet shaped separators 80 interposed therebetween such that respective longitudinal directions thereof are aligned, and are wound with a winding axis WL and as a center. The positive electrode plate 50 includes a positive electrode current collecting foil 52 and a positive electrode active material layer 54 arranged on one surface or both surfaces (both surfaces herein) of the positive electrode current collecting foil 52 to extend in the longitudinal direction. In an end portion of the positive electrode current collecting foil 52 at one side in the winding axis WL direction (that is, a sheet width direction orthogonal to the longitudinal direction), a portion (that is, a positive electrode current collecting foil exposed portion 52a) in which the positive electrode active material layer 54 is not formed and the positive electrode current collecting foil 52 is exposed is provided in a strip shape along the end portion. The negative electrode plate 70 includes a negative electrode current collecting foil 72 and a negative electrode active material layer 74 arranged on one surface or both surfaces (both surfaces herein) of the negative electrode current collecting foil 72 to extend in the longitudinal direction. In an end portion of the negative electrode current collecting foil 72 at the other side in the winding axis WL direction (that is, an end portion thereof at an opposite side to the side at which the positive electrode current collecting foil exposed portion 52a is provided), a portion (that is, a negative electrode current collecting foil exposed portion 72a) in which the negative electrode active material layer 74 is not formed and the negative electrode current collecting foil 72 is exposed is provided in a strip shape along the end portion. As for the positive electrode current collecting foil 52, plural positive electrode current collecting foil exposed portions 52a are stacked in a thickness direction of the electrode body 20. The stacked plural positive electrode current collecting foil exposed portions 52a are joined to the positive electrode current collector 44 by laser welding (that is, a laser welded portion is provided). As for the negative electrode current collecting foil 72, plural negative electrode current collecting foil exposed portions 72a are stacked in the thickness direction of the electrode body 20. The stacked plural negative electrode current collecting foil exposed portions 72a are joined to the negative electrode current collector 64 by laser welding (that is, a laser welded portion is provided). The positive electrode current collector 44 is electrically connected to the positive electrode terminal 42 used for external connection to achieve conduction between inside and outside of the case 30 (see FIG. 1). Similarly, the negative electrode current collector 64 is electrically connected to the negative electrode terminal 62 used for external connection to achieve conduction between inside and outside of the case 30 (see FIG. 1). The positive electrode current collector 44 can have, for example, a plate shape. A thickness of a portion of the positive electrode current collector 44 joined to the positive electrode current collecting foil exposed portions 52a can be, for example, 0.5 mm to 3 mm. The negative electrode current collector 64 can have, for example, a plate shape. A thickness of a portion of the negative electrode current collector 64 joined to the negative electrode current collecting foil exposed portions 72a can be, for example, 0.5 mm to 3 mm.

An insulating member (not illustrated) that gives insulation between the positive electrode terminal 42 and the sealing member 34 can be arranged between the positive electrode terminal 42 and the sealing member 34. The insulating member is, for example, formed of a resin member having an electrical insulation property. Examples of such resin include, for example, polyolefin resin, such as, polypropylene (PP), or the like, fluororesin, such as perfluoroalkoxyethylene copolymer (PFA), polytetrafluoroethylene (PTFE), or the like, polyphenylene sulfide (PPS), or the like. The insulating member may be arranged between the negative electrode terminal 62 and the sealing member 34, between the positive electrode current collector 44 and the sealing member 34, and between the negative electrode current collector 64 and the sealing member 34.

Examples of the positive electrode current collecting foil 52 include, for example, an aluminum foil or the like. A thickness of the positive electrode current collecting foil 52 can be, for example, 5 μm to 20 μm. The positive electrode active material layer 54 includes a positive electrode active material. As the positive electrode active material, a known positive electrode material used for a lithium-ion secondary battery may be used, and examples of the positive electrode material include a lithium composite metal oxide (for example, LiNi_{1/3}CO_{1/3}Mn_{1/3}O₂, LiNiO₂, LiCoO₂, LiFeO₂, LiMn₂O₄, LiNi_{0.5}Mn_{1.5}O₄, LiCrMnO₄, LiFePO₄, or the like). The positive electrode active material layer 54 may include a conductive material, a binder, or the like. As the conductive material, for example, carbon black, such as acetylene black (AB) or the like, some other carbon material (graphite or the like) can be preferably used. As the binder, for example, polyvinylidene fluoride (PVDF) or the like can be used. The positive electrode active material layer 54 can be formed by dispersing a positive electrode material and a material (a conductive material, a binder, or the like) used as necessary in a proper solvent (for example, N-methyl-2-pyrrolidone: NMP), preparing a composition (a positive electrode mixture paste) in a paste state (or a slurry state), applying a proper amount of the composite on a surface of the positive electrode current collecting foil 52, and drying.

Examples of the negative electrode current collecting foil 72 include, for example, a copper foil or the like. A thickness of the negative electrode current collecting foil 72 can be, for example, 5 μm to 20 μm. The negative electrode active material layer 74 includes a negative active electrode material. As the negative electrode active material, for example, a carbon material, such as graphite, hard carbon, soft carbon, or the like, can be used. The negative electrode active material layer 74 may further include a binder, a thickener, or the like. As the binder, for example, styrene butadiene rubber (SBR) or the like can be used. As the thickener, for example, carboxymethyl cellulose (CMC) or the like can be used. The negative electrode active material layer 74 can be formed, for example, by dispersing a negative material active material and a material (a binder or the like) used as necessary in a proper solvent (for example, an ion exchanged water), preparing a composite in a paste state (or a slurry state), applying a proper amount of the composite on a surface of the negative electrode current collecting foil 72, and drying.

As the separator 80, various microporous sheets similar to known microporous sheets can be used. Examples of the separator 80 include a microporous resin sheet formed of a resin, such as, for example, polyethylene (PE), polypropylene (PP), or the like. The microporous resin sheet may have a single-layer structure, and may have a multilayer structure including two or more layers (for example, a three-layer structure in which a PP layer is stacked on both surface of a PE layer). The separator 80 may include a heat resistance layer (HRL).

A nonaqueous electrolyte similar to a known nonaqueous electrolyte can be used. For example, a nonaqueous electrolyte obtained by making an organic solvent (a nonaqueous solvent) contain a supporting salt can be used. As the nonaqueous solvent, an aprotic solvent, such as carbonates, esters, ethers, or the like, can be used. Among them, carbonates, for example, ethylene carbonate (EC), diethyl carbonate (DEC), dimethyl carbonate (DMC), ethyl methyl carbonate (EMC), or the like, can be preferably employed. Alternatively, a fluorine-based solvent of fluorinated carbonate, such as monofluoroethylene carbonate (MFEC), difluoroethylene carbonate (DFEC), monofluoromethyl difluoromethyl carbonate (F-DMC), trifluorodimethyl carbonate (TFDMC), or the like, can be preferably used. One of the nonaqueous solvents described above can be individually used or two or more thereof can be combined as appropriate and used. As the supporting salt, a lithium salt, such as, for example, LiPF₆, LiBF₄, LiClO₄, or the like, can be preferably used. A concentration of the supporting salt is not particularly limited, but is preferably, for example, about 0.7 mol/L or more and about 1.3 mol/L or less. Note that the nonaqueous electrolyte may include some other component than the above-described nonaqueous solvent, supporting salt, or the like, unless effects of the present technology are remarkably impaired. The nonaqueous electrolyte can contain various additives, such as, for example, a gas generating agent, a film forming agent, a dispersant, a thickener, or the like.

A power storage device, such as the nonaqueous electrolyte secondary battery 100 or the like, can be used for various applications, and can be preferably used as a power source (a drive power source) for a motor mounted on a vehicle, such as, for example, a passenger vehicle, a truck, or the like. There is no particular limitation on a vehicle type. Examples of the vehicle type include, for example, a plug-in hybrid electric vehicle (PHEV), a hybrid electric vehicle (HEV), a battery electric vehicle (BEV), or the like.

A shape of a power storage device disclosed herein is not limited to a rectangular shape, and the power storage device may be a coin-type battery, a button-type battery, a cylindrical battery, or the like, and may be formed as a laminate case type battery. A battery disclosed herein can be a polymer battery using a polymer electrolyte, instead of the nonaqueous electrolyte, an all-solid state battery using a solid electrolyte, or the like.

A method for manufacturing a power storage device disclosed herein will be described below. The manufacturing method disclosed herein includes a welding step of joining stacked plural current collecting foils of an electrode body and a current collector (the positive electrode current collector 44 or the negative electrode current collector 64) by laser welding. The welding step specifically incudes applying, while pressing the stacked plural current collecting foils against the current collector, a tensile force to the stacked plural current collecting foils that are pressed in a predetermined straight line direction in at least one of the positive electrode and the negative electrode, and irradiating a portion of a surface of the stacked plural current collecting foils that are pressed against the current collector located in the predetermined straight line direction with laser light. As described above, by applying a tensile force to the stacked plural current collecting foils in the predetermined straight line direction, wrinkles of the current collecting foils can be uniformly stretched. Thus, gaps between the current collecting foils are reduced due to reduction of the wrinkles of the current collecting foils that are pressed against the current collector. As a result, in laser welding of the stacked plural current collecting foils that are pressed against the current collector and the current collector, welding stability can be increased. For example, generation of spatters, generation of blowholes, rapture of the current collecting foils, or the like, that can occur due to gaps between the current collecting foils can be suppressed. The manufacturing method disclosed herein may include, in addition to the welding step, for example, a preparing step, an assembling step, an accommodating step, a sealing step, an injecting step, or the like as necessary in an arbitrary order.

In the preparing step, for example, an electrode body is prepared. The electrode body may be a wound electrode body, such as the electrode body 20 described above, and may be a stacked electrode body in which plural positive electrode plates and plural negative electrode plates are alternately stacked with a separator interposed therebetween. Herein, the electrode body 20 will be described as an example.

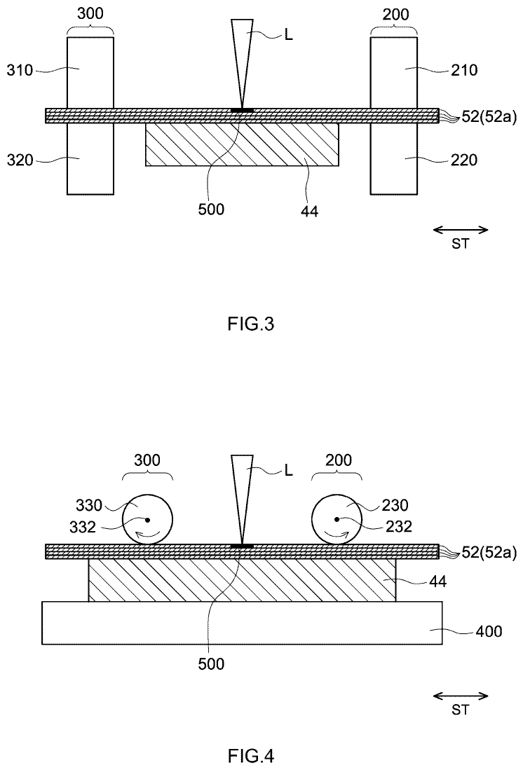

Next, the welding step will be described. Herein, a method for laser welding the current collecting foil (the positive electrode current collecting foil 52) in the positive electrode 40 and the current collector (the positive electrode current collector 44) will be described. FIG. 3 is a schematic view roughly illustrating a laser welding method according to a first preferred embodiment. As illustrated in FIG. 3, first, the plural positive electrode current collecting foils 52 (specifically, the positive electrode current collecting foil exposed portions 52a) are stacked. A number of the positive electrode current collecting foils 52 is not particularly limited, and can be, for example, 10 to 120 or about 20 to 100. In this preferred embodiment, a first pressurizer 200 that pressurizes the stacked plural positive electrode current collecting foils 52 in the stacking direction and a second pressurizer 300 that pressurizes the stacked plural positive electrode current collecting foils 52 in the stacking direction in a different position from a position where the first pressurizer 200 pressurizes the positive electrode current collecting foils 52 are provided. In this preferred embodiment, the first pressurizer 200 nips the stacked plural positive electrode current collecting foil exposed portions 52a between a first upper jig 210 arranged on a surface of the stacked plural positive electrode current collecting foil exposed portions 52a at one side and a first lower jig 220 arranged on a surface of the stacked plural positive electrode current collecting foil exposed portions 52a at the other side from the stacking direction. The second pressurizer 300 nips the stacked plural positive electrode current collecting foil exposed portions 52a between a second upper jig 310 arranged on the surface of the stacked plural positive electrode current collecting foil exposed portions 52a at one side and a second lower jig 320 arranged on the surface of the stacked plural positive electrode current collecting foil exposed portions 52a at the other side from the stacking direction. The first pressurizer 200 preferably pressurizes the stacked plural positive electrode current collecting foil exposed portions 52a in the stacking direction such that there is no gap between the stacked plural positive electrode current collecting foil exposed portions 52a. The second pressurizer 300 preferably pressurizes the stacked positive electrode current collecting foil exposed portion 52a in the stacking direction such that there is no gap between the stacked plural positive electrode current collecting foil exposed portions 52a. Note that, herein, the first upper jig 210, the first lower jig 220, the second upper jig 310, and the second lower jig 320 are illustrated as separate independent jigs, but as long as the first pressurizer 200 and the second pressurizer 300 can be provided, the first upper jig 210, the first lower jig 220, the second upper jig 310, and the second lower jig 320 may be an integrated jig formed of in an arbitrary combination thereof.

Next, with the stacked plural positive electrode current collecting foil exposed portions 52a nipped by the first pressurizer 200 and the second pressurizer 300, the stacked plural positive electrode current collecting foil exposed portions 52a are pressed against a surface of the positive electrode current collector 44. Herein, a portion of the stacked plural positive electrode current collecting foil exposed portions 52a pressed against the surface of the positive electrode current collector 44 is located between the first pressurizer 200 and the second pressurizer 300. At this time, it is preferable that gaps are not generated between the stacked plural positive electrode current collecting foil exposed portions 52a and the surface of the positive electrode current collector 44. Thus, the welding stability is increased. There is a laser irradiation portion 500 that is irradiated with laser light L on the surface of the stacked plural positive electrode current collecting foil exposed portions 52a pressed against the surface of the positive electrode current collector 44. The laser irradiation portion 500 is, in other words, a laser welding scheduled portion.

Next, in a direction (in a straight line direction ST in FIG. 3) in which the first pressurizer 200 and the second pressurizer 300 are arranged, an external force is given to apply a tensile force in a direction in which the stacked plural positive electrode current collecting foil exposed portions 52a are stretched. That is, a portion of the positive electrode current collecting foil exposed portions 52a that contacts the positive electrode current collector 44 is stretched (the tensile force is applied thereto). There is no particular limitation on a method for applying the tensile force. For example, an external force is given to the stacked plural positive electrode current collecting foil exposed portions 52a nipped by the first pressurizer 200 (the stacked plural positive electrode current collecting foil exposed portions 52a are pulled) in an opposite direction to a direction toward the second pressurizer 300 (a direction toward a right side in FIG. 3), thereby achieving application of the tensile force thereto). For example, with the first lower jig 220 fixed, the first upper jig 210 can be moved in the opposite direction to the direction toward the second pressurizer 300 to apply a tensile force to the stacked plural positive electrode current collecting foil exposed portions 52a. As another option, with the first upper jig 210 fixed, the first lower jig 220 may be moved in the opposite direction to the direction toward the second pressurizer 300 to apply a tensile force to the stacked plural positive electrode current collecting foil exposed portions 52a. As still another option, both the first upper jig 210 and the first lower jig 220 may be moved in the opposite direction to the direction toward the second pressurizer 300 to apply a tensile force to the stacked plural positive electrode current collecting foil exposed portions 52a. That is, in the first pressurizer 200, the stacked plural positive electrode current collecting foil exposed portions 52a may be pulled while being nipped by the first pressurizer 200. On the other hand, the second pressurizer 300 may fix the stacked plural positive electrode current collecting foil exposed portions 52a while pressurizing the stacked positive electrode current collecting foil exposed portions 52a in the stacking direction. Similar to the first pressurizer 200 described above, the second upper jig 310 and/or the second lower jig 320 may be moved in an opposite direction to a direction toward the first pressurizer 200 (a direction toward a left side in FIG. 3) to apply a tensile force to the stacked plural positive electrode current collecting foil exposed portions 52a. In a manner described above, when the first pressurizer 200 and/or the second pressurizer 300 are moved to apply a tensile force to the stacked plural positive electrode current collecting foil exposed portions 52a, the tensile force is generated in the straight line direction in which the first pressurizer 200 and the second pressurizer 300 are arranged. Thus, wrinkles of the stacked plural positive electrode current collecting foil exposed portions 52a between the first pressurizer 200 and the second pressurizer 300 are stretched, so that gaps between the stacked plural positive electrode current collecting foil exposed portions 52a in the stacking direction are reduced.

The tensile force applied to the stacked plural positive electrode current collecting foil exposed portions 52a is preferably generated only in one straight line direction (one direction). In a case where tensile forces are applied in plural directions or in a case where the tensile force is applied in a radial direction of a circle, wrinkles tend to be generated in the stacked plural positive electrode current collecting foil exposed portions 52a. With a tensile force applied only in one straight line direction, the stacked plural positive electrode current collecting foil exposed portions 52a are brought into close contact with each other uniformly, so that the gaps between the stacked plural positive electrode current collecting foil exposed portions 52a are preferably reduced.

Note that, in the method described above, the stacked plural positive electrode current collecting foil exposed portions 52a are pressed against the positive electrode current collector 44, and then, a tensile force is applied thereto, but an order of pressing the stacked plural positive electrode current collecting foil exposed portions 52a and applying the tensile force is not limited. For example, after the tensile force is applied to the stacked plural positive electrode current collecting foil exposed portions 52a, the stacked plural positive electrode current collecting foil exposed portions 52a may be pressed against the positive electrode current collector 44. The stacked plural positive electrode current collecting foil exposed portions 52a can be pressed against the positive electrode current collector 44 in a state where the wrinkles of the stacked plural positive electrode current collecting foil exposed portions 52a are stretched by applying the tensile force on the stacked plural positive electrode current collecting foil exposed portions 52a before the stacked plural positive electrode current collecting foil exposed portions 52a are pressed against the positive electrode current collector 44, so that the gaps between the positive electrode current collecting foil exposed portions 52a and the positive electrode current collector 44 can be preferably reduced.

The first pressurizer 200 and the second pressurizer 300 may be provided after the stacked plural positive electrode current collecting foil exposed portions 52a and the positive electrode current collector 44 are placed to be superimposed. In FIG. 3, in the first pressurizer 200 and the second pressurizer 300, the jigs are placed to directly contact the stacked plural positive electrode current collecting foil exposed portions 52a from both sides in the stacking direction, and thus, the stacked plural positive electrode current collecting foil exposed portions 52a are nipped between the jigs. However, as in another preferred embodiment described later, with the stacked plural positive electrode current collecting foil exposed portions 52a and the positive electrode current collector 44 superimposed, a surface of the stacked plural positive electrode current collecting foil exposed portions 52a and the positive electrode current collector 44 may be nipped together.

Next, the surface of the stacked plural positive electrode current collecting foil exposed portions 52a pressed against the positive electrode current collector 44 is irradiated with the laser light L. At this time, at least a portion of a region of the surface of the stacked plural positive electrode current collecting foil exposed portions 52a pressed against the positive electrode current collector 44 located in the straight light direction in which the tensile force is generated is irradiated with the laser light L. That is, the laser irradiation portion 500 is positioned to extend in the straight line direction ST in which the tensile force is generated. Thus, the stacked plural positive electrode current collecting foil exposed portions 52a and the positive electrode current collector 44 can be laser welded. Note that there may be only one portion (laser irradiation portion 500) to be laser welded, and there may be plural portions to be laser welded.

There is no particular limitation on a type of the laser light L. Examples of the type of the laser light L include YAG laser, CO₂ laser, semiconductor laser, disk laser, fiber laser, or the like. A laser output, a laser irradiation time, a laser input heat amount, or the like is adjusted as appropriate in accordance with materials of the current collecting foils, the current collectors, or the like, and is not particularly limited.

A method for laser welding the negative electrode current collecting foil 72 and the negative electrode current collector 64 in the negative electrode 60 may be similar to the above-described method used for laser welding the positive electrode current collecting foil 52 and the positive electrode current collector 44.

For example, this can be understood by replacing “positive electrode” in the description above with “negative electrode.” In this preferred embodiment, the negative electrode current collecting foil 72 (specifically, the stacked plural negative electrode current collecting foil exposed portions 72a) and the negative electrode current collector 64 are laser welded in a similar manner used for laser welding for the positive electrode 40. Thus, the positive electrode current collector 44 and the negative electrode current collector 64 are mounted to the electrode body 20.

In the assembling step, for example, the positive electrode current collector 44 mounted to the electrode body 20 is joined to the positive electrode terminal 42 mounted to the sealing member 34, and the negative electrode current collector 64 mounted to the electrode body 20 is joined to the negative electrode terminal 62 mounted to the sealing member 34, so that an assembly including the sealing member 34, the electrode body 20, the positive electrode terminal 42, the positive electrode current collector 44, the negative electrode terminal 62, and the negative electrode current collector 64 is constructed. A method for mounting each member may follow a known method. For example, each member may be joined to another member by caulking, laser welding, ultrasonic welding, resistance welding, or the like. Note that a current collector of each electrode and a terminal may not be joined after the welding step but may be joined in advance before the welding step.

In the accommodating step, for example, the electrode body 20 is accommodated in a case body 12. Herein, the electrode body 20 of the constructed assembly described above is accommodated in the case body 12 and the sealing member 34 is placed to fit an opening of the case body 12. At this time, an insulating film formed in a bag shape or a box shape in advance may be arranged between the electrode body 20 and the case body 12.

In the searing step, for example, a portion where the sealing member 34 and the case body 12 overlap is welded to seal the case body 12. A welding method may follow a known method. The case body 12 is welded, for example, by laser welding.

In the injecting step, a nonaqueous electrolyte is injected from an injection port provided in the case 30 in accordance with a known method. Note that, depending on a type of the power storage device, the injecting step is omitted.

Thereafter, for example, initial charging, aging treatment, or the like is performed under a predetermined condition, thereby fabricating the nonaqueous electrolyte secondary battery 100 (power storage device) in a usable state.

Another preferred embodiment of the laser welding method in the welding step will be described below. FIG. 4 is a schematic view roughly illustrating a laser welding method according to a second preferred embodiment. FIG. 5 is a schematic view illustrating a method for pressurizing a laser light irradiation portion in a stacking direction of current collecting foils. As illustrated in FIG. 4, in the second preferred embodiment, the first pressurizer 200 and the second pressurizer 300 are provided in a portion where the stacked plural positive electrode current collecting foil exposed portions 52a and the positive electrode current collector 44 are superimposed. The positive electrode current collector 44 is arranged on a base portion 400. The base portion 400 is a portion on which a welding target is placed in laser welding. The base portion 400 may be similar to a base portion used for known laser welding.

In the first pressurizer 200, a first roller 230 is arranged on a surface of the stacked plural positive electrode current collecting foil exposed portions 52a. The stacked plural positive electrode current collecting foil exposed portions 52a and the positive electrode current collector 44 are nipped between the first roller 230 and the base portion 400, and the stacked plural positive electrode current collecting foil exposed portions 52a are pressurized in the stacking direction thereof. In the second pressurizer 300, a second roller 330 is arranged on the surface of the stacked plural positive electrode current collecting foil exposed portions 52a. The stacked plural positive electrode current collecting foil exposed portions 52a and the positive electrode current collector 44 are nipped between the second roller 330 and the base portion 400, and the stacked plural positive electrode current collecting foil exposed portions 52a are pressurized in the stacking direction thereof. Note that the first pressurizer 200 and/or the second pressurizer 300 may be provided in a position where the positive electrode current collector 44 is not arranged (see an arrangement of the first pressurizer 200 and the second pressurizer 300 in FIG. 3).

As illustrated in FIG. 4, the first roller 230 can be configured to be rotatably driven on a spot with an axis 232 as a center. A tensile force is applied to the stacked plural positive electrode current collecting foil exposed portions 52a by rotating the first roller 230 in the predetermined straight line direction ST in which the tensile force is applied. Specifically, the first roller 230 may be rotated (counterclockwise in FIG. 4) to cause the positive electrode current collecting foil exposed portions 52a to stretch toward an opposite side to the laser irradiation portion 500 in a portion where the first roller 230 contacts the positive electrode current collecting foil exposed portions 52a. The first roller 230 may be kept rotating but rotation of the first roller 230 may be stopped by a balance of force in the straight line direction ST.

A configuration of the second roller 330 may be similar to that of the first roller 230, and the second roller 330 can be configured to be rotatably driven at a spot with an axis 332 as a center. The second roller 330 may not be rotated when the first roller 230 is rotated. That is, the stacked plural positive electrode current collecting foil exposed portions 52a may be pressurized from the stacking direction thereof, and a position of the stacked plural positive electrode current collecting foil exposed portions 52a may be fixed. Therefore, in this case, in the second pressurizer 300, instead of the second roller 330, the second upper jig 310 as in the first embodiment described above may be arranged. Alternatively, even when the first roller 230 is rotated, the second roller 330 may be rotated in the predetermined straight line direction ST in which a tensile force is applied. Specifically, in a portion where the second roller 330 and the positive electrode current collecting foil exposed portions 52a contact each other, the second roller 330 may be rotated (clockwise in FIG. 4) to cause the positive electrode current collecting foil exposed portions 52a to stretch toward the opposite side to the laser irradiation portion 500. A rotation direction of the first roller 230 and a rotation direction of the second roller 330 may be opposite to each other.

As illustrated in FIG. 5, before a tensile force is applied to the stacked plural positive electrode current collecting foil exposed portions 52a, the first pressurizer 200 is preferably moved in the straight line direction ST so as to pass the laser irradiation portion 500 (an arrow in FIG. 5 indicates a moving direction of the first pressurizer 200). In other words, in the laser irradiation portion 500, it is preferable that the tensile force is applied to the stacked plural positive electrode current collecting foil exposed portions 52a continuously after the stacked plural positive electrode current collecting foil exposed portions 52a are pressurized in the stacking direction thereof. Note that, in moving the first pressurizer 200, the stacked plural positive electrode current collecting foil exposed portions 52a are preferably fixed by the second pressurizer 300. Thus, gaps between the stacked plural positive electrode current collecting foil exposed portions 52a in the laser irradiation portion 500 can be reduced. Note that this step is not limited to the second preferred embodiment and may be employed in another preferred embodiment.

In the second preferred embodiment, wrinkles of the laser irradiation portion 500 are stretched by applying a tensile force to the stacked plural positive electrode current collecting foil exposed portions 52a by rotating the first roller 230 in the straight line direction ST, and the laser irradiation portion 500 is irradiated with the laser light L to perform laser welding. In the second embodiment, the tensile force applied to the stacked plural positive electrode current collecting foil exposed portions 52a is generated only in the straight line direction ST by rotation of the first roller 230, and therefore, the tensile force is more uniformly applied, so that the wrinkles of the positive electrode current collecting foil exposed portions 52a tend to be stretched and the gaps between the stacked positive electrode current collecting foil exposed portions 52a are preferably reduced.

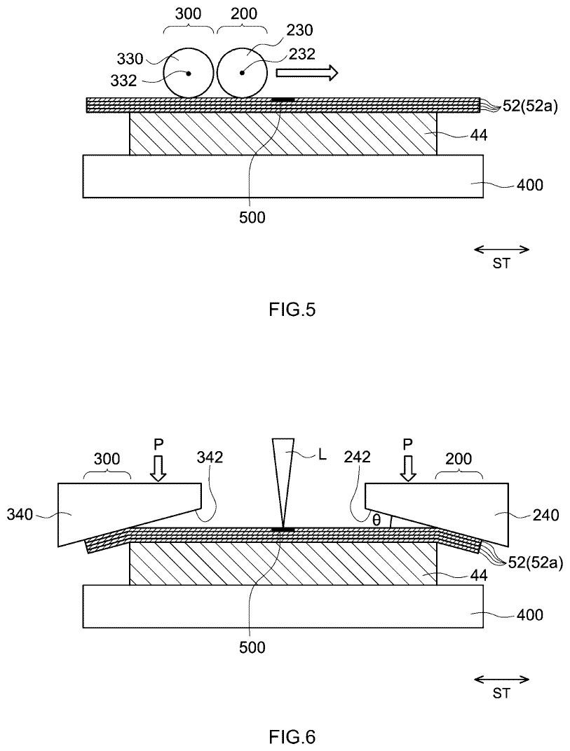

FIG. 6 is a schematic view roughly illustrating a laser welding method according to a third preferred embodiment. In FIG. 6, in the straight line direction ST in which a tensile force is applied, the stacked plural positive electrode current collecting foil exposed portions 52a and the positive electrode current collector 44 are arranged such that end portions of the stacked plural positive electrode current collecting foil exposed portions 52a protrude from an end portion of the positive electrode current collector 44. In the first pressurizer 200, a first pressing plate 240 is arranged on a surface of the stacked plural positive electrode current collecting foil exposed portions 52a. In this case, a second pressing plate 340 is arranged on the surface of the stacked plural positive electrode current collecting foil exposed portions 52a in the second pressurizer 300.

The first pressing plate 240 is arranged such that an opposed surface 242 opposed to a surface of the stacked plural positive electrode current collecting foil exposed portions 52a is inclined with a portion thereof located closer to end portions of the stacked plural positive electrode current collecting foil exposed portions 52a is lowered. Next, the stacked plural positive electrode current collecting foil exposed portions 52a are pressurized by the first pressing plate 240 in the stacking direction thereof such that the opposed surface 242 of the first pressing plate 240 contacts both a portion of the stacked plural positive electrode current collecting foil exposed portions 52a superimposed on one end portion of the positive electrode current collector 44 and an end portion of the stacked plural positive electrode current collecting foil exposed portions 52a protruding from the end portion of the positive electrode current collector 44. At this time, the first pressing plate 240 pressurizes the stacked plural positive electrode current collecting foil exposed portions 52a in a direction (an up-down direction in FIG. 6) in which the positive electrode current collector 44 and the stacked plural positive electrode current collecting foil exposed portion 52a are superimposed. An arrow P in FIG. 6 indicates a pressurizing direction in which the first pressing plate 240 or the second pressing plate 340 applies a pressure. A vector of pressurization of the first pressing plate 240 is decomposed into a force that pressurizes the stacked plural positive electrode current collecting foil exposed portions 52a from the stacking direction thereof and a force that pulls the stacked plural positive electrode current collecting foil exposed portions 52a (in an opposite direction to a direction toward the second pressurizer 300 in the straight line direction ST) by making the opposed surface 242 of the first pressing plate 240 inclined as described above. As a result, a tensile force can be applied to the stacked plural positive electrode current collecting foil exposed portions 52a in the straight line direction ST.

An inclination angle θ of the opposed surface 242 of the first pressing plate 240 with respect to the positive electrode current collecting foil exposed portions 52a is not particularly limited, but may be, for example, 5 degrees or more, 10 degrees or more, or 15 degrees or more. The larger the inclination angle θ is, the stronger a tensile force applied to the stacked plural positive electrode current collecting foil exposed portions 52a becomes, so that the wrinkles of the stacked plural positive electrode current collecting foil exposed portions 52a can be stretched more effectively. The inclination angle θ may be, for example, 75 degrees or less, 60 degrees or less, or 45 degrees or less. When the inclination angle θ is too large, a force that pressurizes the stacked plural positive electrode current collecting foil exposed portions 52a in the stacking direction thereof can be weakened and the stacked plural positive electrode current collecting foil exposed portions 52a are insufficiently fixed in laser welding, and therefore, the welding stability may be reduced.

In FIG. 6, the first pressing plate 240 incudes the opposed surface 242 as an inclination surface, but the first pressing plate 240 is not limited thereto. The first pressing plate 240 may be, for example, a cuboid plate. In this case, the opposed surface 242 of the first pressing plate 240 may be inclined such that the inclination angle θ with respect to the surface of the stacked plural positive electrode current collecting foil exposed portions 52a is achieved, and thus, the stacked plural positive electrode current collecting foil exposed portions 52a may be pressurized from the stacking direction.

The second pressing plate 340 in the second pressurizer 300 may have a similar configuration to that of the first pressing plate 240. It is understood that an opposed surface 342 of the second pressing plate 340 opposed to a surface of the stacked plural positive electrode current collecting foil exposed portions 52a corresponds to the opposed surface 242 of the first pressing plate 240. A pressurizing method in the second pressurizer 300 may be similar to that in the first pressurizer 200. Note that, although, in this embodiment, the second pressing plate 340 is arranged in the second pressurizer 300, the second pressurizer 300 may be configured to only pressurize the stacked plural positive electrode current collecting foil exposed portions 52a from the stacking direction to fix the stacked plural positive electrode current collecting foil exposed portions 52a, and an aspect of the second pressurizer 300 in another embodiment can be employed as appropriate.

In FIG. 6, the first pressing plate 240 and the second pressing plate 340 are independent from each other. However, the first pressing plate 240 and the second pressing plate 340 may be configured from a single plate having portions corresponding to both the opposed surface 242 of the first pressing plate 240 and the opposed surface 342 of the second pressing plate 340. For example, a plate having a through hole through which the laser light L passes and having a pair of inclination surfaces (corresponding to the opposed surface 242 of the first pressing plate 240 and the opposed surface 342 of the second pressing plate 340) opposed to each other with the through hole interposed therebetween in a predetermined straight line direction can be employed.

Preferred embodiments of the manufacturing method disclosed herein have been described above. However, the preferred embodiments described above are merely examples. The present technology can be implemented in various other embodiments. The technology described in the scope of claims includes various modifications and changes of the preferred embodiments described as examples above. For example, a portion of the preferred embodiments described above can be replaced with some other modified aspect. Some other modified aspect can be added to the preferred embodiments described above. Additionally, a technical feature can be deleted as appropriate unless the technical feature is described as an essential element.

As described above, the following items are given as specific aspects of the technology disclosed herein.
First Item: A method for manufacturing a power storage device, the power storage device including a positive electrode including stacked plural positive electrode current collecting foils and a positive electrode current collector connected to the stacked positive electrode current collecting foils, and a negative electrode including stacked plural negative electrode current collecting foils and a negative electrode current collector connected to the stacked negative electrode current collecting foils, the method including applying, while pressing the stacked plural current collecting foils against the current collector, a tensile force to the stacked plural current collecting foils that are pressed in a predetermined straight line direction in at least one of the positive electrode and the negative electrode, and irradiating a portion of a surface of the stacked plural current collecting foils that are pressed against the current collector located in the predetermined straight line direction with laser light.
Second Item: The method according to the first item, in which, in the predetermined straight line direction, a first pressurizer that pressurizes the stacked plural current collecting foils in the stacking direction and a second pressurizer that pressurizes the stacked plural current collecting foils in the stacking direction in a different position from a position where the first pressurizer pressurizes the stacked plural current collecting foils are provided and a tensile force is applied to the stacked plural current collecting foils located between the first pressurizer and the second pressurizer.
Third Item: The method according to the second item, in which, while the stacked plural current collecting foils are nipped from the stacking direction in the first pressurizer, an external force is given to the stacked plural current collecting foils in an opposite direction to a direction toward the second pressurizer to apply the tensile force.
Fourth Item: The method according to the second or third item, in which, in the first pressurizer, a roller is arranged on a surface of the stacked plural current collecting foils and the tensile force is applied to the stacked plural current collecting foils by rotating the roller in the predetermined straight line direction.
Fifth Item: The method according to the second or third item, further comprising placing the stacked plural positive electrode current collecting foils overlapping the current collector such that end portions of the positive electrode current collecting foils protrude from an end portion of the current collector in the predetermined straight line direction, and arranging, in the first pressurizer, a pressing plate at a side where the current collecting foils are present such that an opposed surface of the pressing plate opposed to the current collecting foils is inclined with respect to the surface of the current collecting foils and pressurizing the end portions of the stacked plural current collecting foils protruding from the end portion of the current collector and the stacked plural current collecting foils located on the end portion of the current collector by with the opposed surface.
Sixth Item: The method according to any one of the second to fifth items, further comprising moving, before irradiating the portion with the laser light, the first pressurizer in the straight line direction such that the laser light passes the surface of the stacked plural current collecting foils that is irradiated with the laser light.

What is claimed is:

1. A method for manufacturing a power storage device, the power storage device including
a positive electrode including stacked plural positive electrode current collecting foils and a positive electrode current collector connected to the stacked positive electrode current collecting foils, and
a negative electrode including stacked plural negative electrode current collecting foils and a negative electrode current collector connected to the stacked negative electrode current collecting foils,
the method comprising:
applying, while pressing the stacked plural current collecting foils against the current collector, a tensile force to the stacked plural current collecting foils that are pressed in a predetermined straight line direction in at least one of the positive electrode and the negative electrode; and
irradiating a portion of a surface of the stacked plural current collecting foils that are pressed against the current collector located in the predetermined straight line direction with laser light.

2. The method according to claim 1, wherein
in the predetermined straight line direction, a first pressurizer that pressurizes the stacked plural current collecting foils in the stacking direction and a second pressurizer that pressurizes the stacked plural current collecting foils in the stacking direction in a different position from a position where the first pressurizer pressurizes the stacked plural current collecting foils are provided and the tensile force is applied to the stacked plural current collecting foils located between the first pressurizer and the second pressurizer.

3. The method according to claim 2, wherein
while the stacked plural current collecting foils are nipped from the stacking direction in the first pressurizer, a force that pulls the stacked plural current collecting foils in an opposite direction to a direction toward the second pressurizer is given to apply the tensile force.

4. The method according to claim 2, wherein
in the first pressurizer, a roller is arranged on a surface of the stacked plural current collecting foils and the tensile force is applied to the stacked plural current collecting foils by rotating the roller in the predetermined straight line direction.

5. The method according to claim 2, further comprising:
placing the stacked plural current collecting foils overlapping the current collector such that end portions of the stacked plural current collecting foils protrude from an end portion of the current collector in the predetermined straight line direction; and
arranging, in the first pressurizer, a pressing plate at a side where the current collecting foils are present such that an opposed surface of the pressing plate opposed to the current collecting foils is inclined with respect to the surface of the current collecting foils and pressurizing the end portions of the stacked plural current collecting foils protruding from the end portion of the current collector by the opposed surface and the stacked plural current collecting foils located on the end portion of the current collector by the opposed surface.

6. The method according to claim 2, further comprising:
moving, before irradiating the portion with the laser light, the first pressurizer in the straight line direction such that the laser light passes the surface of the stacked plural current collecting foils that is irradiated with the laser light.
